(19) United States
(12) Patent Application Publication
(10) Pub. No.: US 2009/0025296 A1
(43) Pub. Date: Jan. 29, 2009

(54) Sliding door and window operating system

(76) Inventor: Robert E. Petner, Burlington, NJ (US)

Correspondence Address: HOLLSTEIN KEATING CATTELL JOHNSON & GOLDSTEIN P.C., WILLOW RIDGE EXECUTIVE OFFICE PARK, 750 ROUTE 73 SOUTH, SUITE 301, MARLTON, NJ, 08053, US

(21) Appl. No.: 11/880,778

(22) Filed: Jul. 24, 2007

(51) Int. Cl. E05D 15/06

(52) U.S. Cl. 49/130

(57) ABSTRACT

A novel sliding door and window operating system is especially conducive for use on sliding patio doors and larger window panels. The system uses a small motor to electrically power and rotate a lead screw enclosed within a casing. A guide block on the lead screw is positioned within an opening, inset into the door or window panel which is to be slideably moved. The motor is actuated by use of a switch. The motor rotates the lead screw which in turn moves the guide block back and forth longitudinally within the casing. As the guide block is located within the inset opening of the door or window panel, as the guide block moves it carries the panel along with it, thus opening and closing the panel.

### BACKGROUND OF THE INVENTION

The use of sliding doors, windows and similar closures, both in residential and commercial spaces, is well known. Transparent sliding window panels, especially, are used in glass patio doors not only for ingress and egress, but also to allow one to look through a relatively wide, floor to ceiling area. Such window panels are usually large and heavy and opening them manually is sometimes difficult. As a result, automatic sliding door and window opening and closing operating systems, which eliminate the need to struggle with a door or window, have been developed. For example, there are door and window systems which employ belt driven pulleys, others which have complex gear operating systems, and some even use light beams to control door and window panel movement. While there are many prior operating systems, these systems are generally complicated to build and involve the use of too many moving parts, many of which are susceptible of breakage. Others become an encumbrance in that they are placed on or adjacent to the door or window, and, at the very least, present an unsightly appearance. Still other operating systems just do not work or work effectively or efficiently.

### SUMMARY OF THE INVENTION

It is thus an object of the present invention to overcome the disadvantages and limitations of prior sliding door and window operating systems.

It is an object of the present invention to provide a sliding door and window operating system which easily and effectively opens and closes door and window panels.

It is another object of the present invention to provide a sliding door and window operating system which is simple in design and uses relatively few moving parts.

It is a further object of the present invention to provide a sliding door and window operating system which is easily installed and maintained.

It is still another object of the present invention to provide a sliding door and window operating system which can be operated remotely or by wired switch.

These and other objectives are accomplished by the present invention, a sliding door and window operating system, especially conducive for use on sliding patio doors and larger window panels. The system uses a small motor to electrically power and rotate a lead screw enclosed within a casing. A guide block on the lead screw is positioned within an opening, inset into the door or window panel which is to be slideably moved. The motor is actuated by use of a switch. The motor rotates the lead screw which in turn moves the guide block back and forth longitudinally within the casing. As the guide block is located within the inset opening of the door or window panel, as the guide block moves, it carries the panel along with it, thus opening and closing the panel.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view showing the lower section of a glass patio door employing the system of the present invention.

FIG. 2 is a view similar to that which is shown in FIG. 1, but in greater detail.

FIG. 3 is a view similar to that which is shown in FIG. 1, but with the slideably door panel partially open.

FIG. 4 is a partial elevation view of the lower section of a glass patio door employing the system of the present invention.

FIG. 5 is a partial end view of the lower section of a glass patio door employing the system of the present invention.

### DETAILED DESCRIPTION OF THE INVENTION

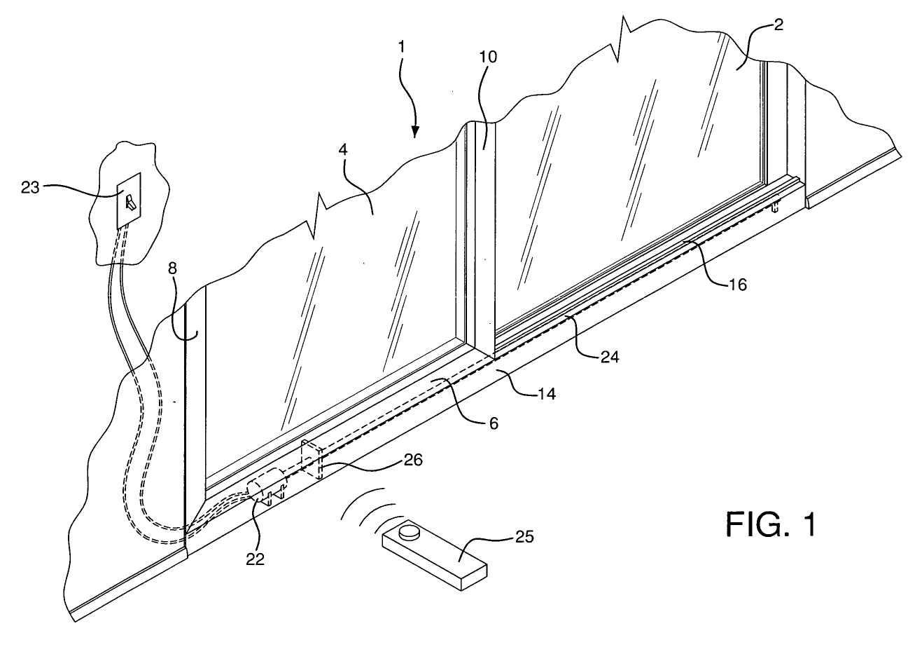

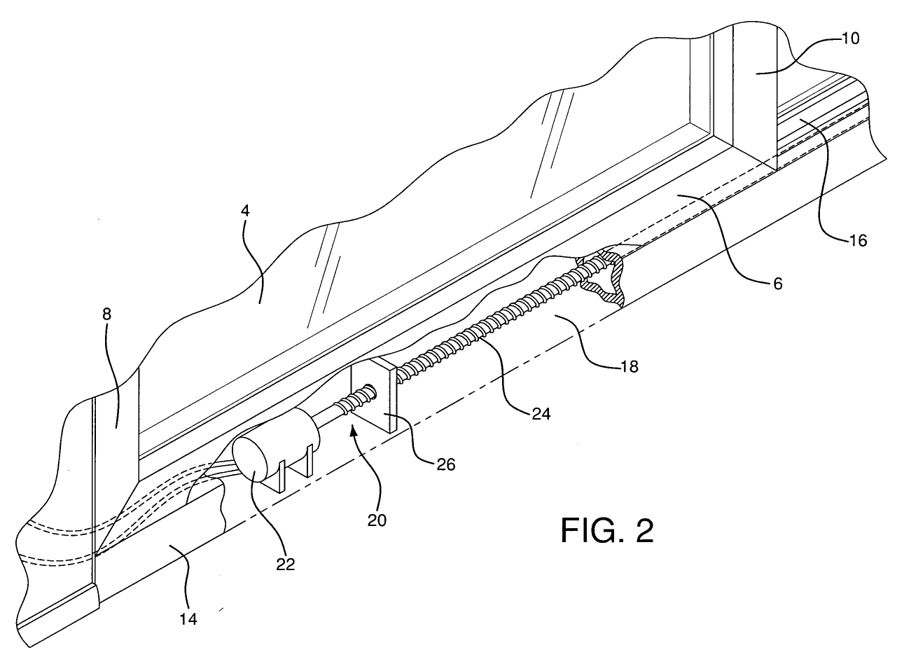

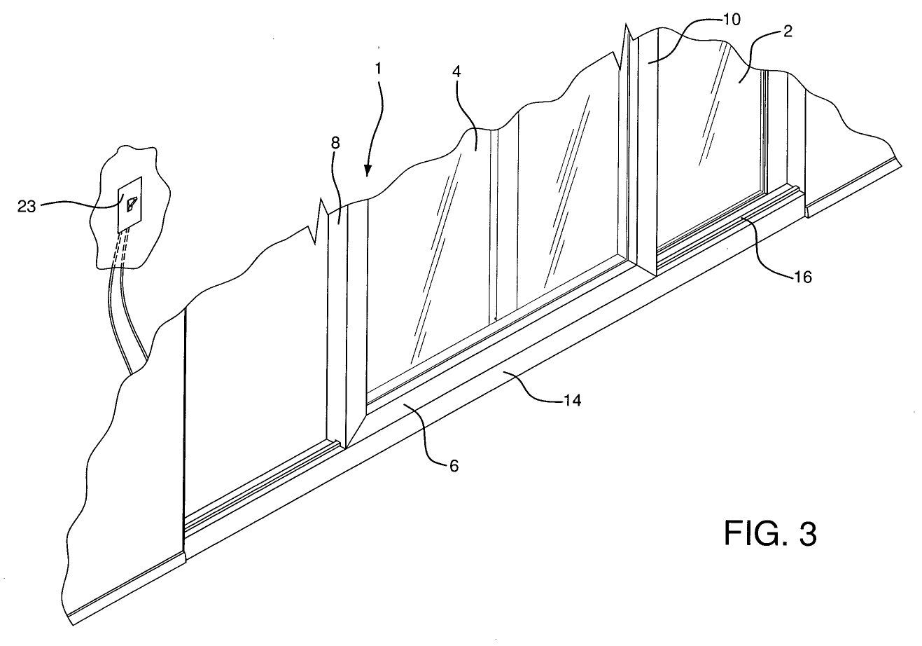

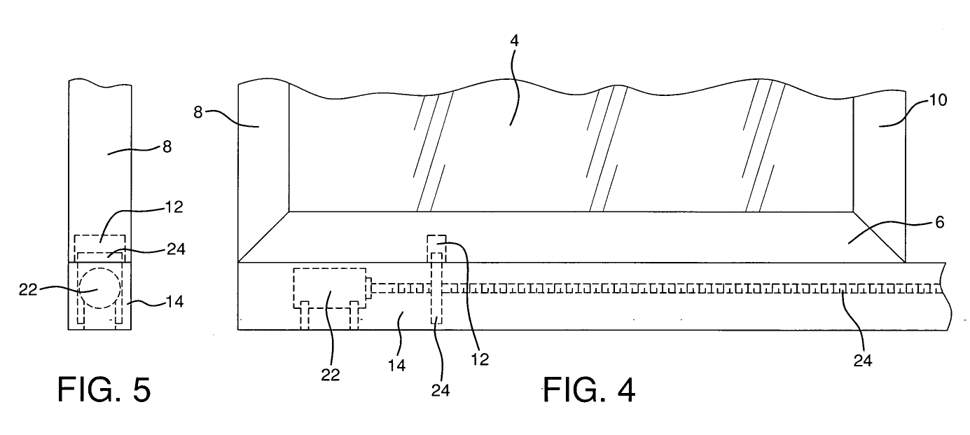

The panel operating system of the present invention is clearly illustrated in FIGS. 1-5. The lower section of patio sliding door unit 1 is shown in FIG. 1. Door unit 1 comprises fixed transparent door panel 2 and slideable transparent door panel 4. Panel 4 is surrounded by frame members 6, 8, and 10. Frame member 6 extends between frame members 8 and 10 and the full width of panel 4. As best seen in FIG. 4, cut-out opening 12 is inset in frame member 6.

Frame member 6 is positioned atop casing 14, which extends the full length of door unit 1 and encloses space 18 in which door conveying system 20 is housed. Frame member 6 is configured to slideably move along tracks 16 on casing 14. System 20 comprises electric motor 22, or equivalent power means. Conveying system 20 also comprises lead screw 24 which is connected to motor 22 and extends substantially the full length of casing 14. Guide block 26 is located around and is configured to be driven back and forth lead screw 24. As seen in FIG. 4, guide block 26 is configured to be positioned within opening 12 inset within frame member 6. Switch 23 is wired from a separate convenient location to activate motor 22. Switch 23 can also be a remote control switch device 25, well known in the art.

When activated, motor 22 rotatably drives lead screw 24. This results in lead screw 24 moving guide block 26 longitudinally back and forth through casing 14. It can be appreciated that, as guide block 24 is moved longitudinally along lead screw 24, it carries frame member 6 and hence door panel 4 with it, on tracks 16 over casing 14. Door panel 4 is thus readily opened and closed in this manner.

It is contemplated that the operating system of the present invention could also be employed to open and close standard window panels, which also could be actuated by wired or remote control switch. It is also anticipated that controllers and/or limit switch and limit sensors can be employed in conjunction with the system described herein, to enhance control of its operation. Such components are known in the art and do not form a part of the invention as disclosed.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. An operating system for door and window panels comprising:
an elongated casing having an enclosed elongated space therein;
a transparent panel mounted adjacent to the casing, said panel having an opening inset therein;
panel conveying means substantially enclosed within the space for slideably moving the panel along the casing, said panel conveying means comprising a guide means inserted into the opening for transmitting movement from the guide means to the panel, shaft means to move the guide means within the space, and power means to rotate the shaft means; and
switch means to activate the power means, whereby activation of the power means rotates the shaft means thereby moving the guide means within the opening to slideably open and close the panel along the casing.

2. The operating system for door and window panels as in claim 1 wherein the panel comprises the moveable panel of a sliding patio door.

3. The operating system for door and window panels as in claim 1 where the panel is in a window.

4. The operating system for door and window panels as in claim 1 where the panel comprises a frame and the opening is inset into the frame.

5. The operating system for door and window panels as in claim 1 where the switch means comprises a remote control operated switch.

6. The operating system for door and window panels as in claim 1 in which the panel is a slideable panel used in conjunction with a fixed panel of a patio sliding door.

7. The operating system for door and window panels as in claim 1 wherein the guide means comprises a guide block and the shaft means comprises a lead screw which moves the guide block longitudinally back and forth within the casing.

8. An operating system for door and window panels comprising:
an elongated casing having an enclosed elongated space therein;
a panel mounted adjacent to the casing, said casing having an opening inset therein;
a panel conveying apparatus substantially enclosed within the space, said conveying apparatus comprising a guide block inserted into the opening and a rotatable shaft, rotatably powered by a motor to move the guide means within the space; and
switch means to activate the motor, whereby activation of the motor rotates the shaft, thereby moving the guide block within the opening to slideably open and close the panel along the casing.

9. The operating system for door and window panels as in claim 8 wherein the panel comprises the moveable panel of a sliding patio door.

10. The operating system for door and window panels as in claim 8 where the panel is in a window.

11. The operating system for door and window panels as in claim 8 where the panel comprises a frame and the opening is inset into the frame.

12. The operating system for door and window panels as in claim 8 where the switch means comprises a remote control operated switch.

13. The operating system for door and window panels as in claim 8 in which the panel is a slideable panel used in conjunction with a fixed panel of a patio sliding door.

14. A sliding patio door comprising:
a fixed window panel;
a slideably moveable window panel having an opening inset therein;
a elongated casing having an enclosed elongated space therein;
panel conveying means substantially enclosed within the space for slideably moving the moveable window panel along the casing, said panel conveying means comprising guide means inserted into the opening in the moveable window panel for transmitting movement to that panel, rotatable shaft means to move the guide means within the space, and power means to rotate the shaft means; and
switch means to activate the power means, whereby activation of the power means rotates the shaft means thereby moving the guide means within the opening to slideably open and close the moveable window panel along the casing.

15. The operating system for door and window panels as in claim 14 where the panel comprises a frame and the opening is inset into the frame.

16. The operating system for door and window panels as in claim 14 where the switch means comprises a remote control operated switch.

17. The operating system for door and window panels as in claim 14 in which the panel is a slideable panel used in conjunction with a fixed panel of a patio sliding door.

18. The operating system for door and window panels as in claim 14 wherein the guide means comprises a guide block and the shaft means comprises a lead screw which moves the guide block longitudinally back and forth within the casing.
